(19) United States
(12) Patent Application Publication
(10) Pub. No.: US 2026/0111833 A1
(43) Pub. Date: Apr. 23, 2026

(54) COMPUTER-IMPLEMENTED METHOD FOR PLANNING AND MONITORING A COLD CHAIN

(71) Applicant: REP IP AG, Zug (CH)

(72) Inventors: Nico ROS, Riehen (CH); Stefan RETZKO, Zürich (CH); Christian WEGMANN, Neuchatel (CH)

(73) Assignee: REP IP AG, Zug (CH)

(21) Appl. No.: 19/152,997

(22) PCT Filed: Jan. 17, 2024
(86) PCT No.: PCT/IB2024/050429

§ 371 Date: Aug. 1, 2025

(30) Foreign Application Priority Data
Feb. 1, 2023 (EP) 23020059.4

(51) Int. Cl. G06Q 10/0832; G06Q 10/083

(52) U.S. Cl. CPC G06Q 10/0832; G06Q 10/08355

(57) ABSTRACT

A computer-implemented method for planning and monitoring a cold chain when transporting temperature-sensitive goods in a temperature-controlled transport container from a starting location to a destination. The method includes creating at least one combination of route sections for at least one transport route from the starting location to the destination; and calculating and displaying an expected course of the internal temperature of the transport container for the at least one combination of route sections based on route section-specific estimated data and container-specific data, the expected course of the internal temperature being within a predefined temperature range. The method also includes recording route section-specific actual data during transport; and during transport, updating the calculation of the expected course of the internal temperature of the transport container for a remaining part of the transport route taking into account the route section-specific actual data.

### CROSS-REFERENCE TO RELATED APPLICATIONS

The present application is a national phase application of PCT Application No. PCT/IB2024/050429, filed Jan. 17, 2024, entitled “COMPUTER-IMPLEMENTED METHOD FOR PLANNING AND MONITORING A COLD CHAIN”, which claims the benefit of European Patent Application No. 23020059.4, filed Feb. 1, 2023, each of which is incorporated by reference in its entirety.

### BACKGROUND OF THE INVENTION

### 1. Field of the Invention

The invention relates to a computer-implemented method for planning and monitoring a cold chain during the transport of temperature-sensitive goods in a temperature-controlled transport container from a starting point to a destination.

### 2. Description of the Related Art

The invention further relates to a data processing system and a computer program product for carrying out such a method.

When transporting temperature-sensitive drugs worldwide, such as vaccines, a prescribed temperature range must be observed throughout the entire transport route from the manufacturer to the patient. The complete assurance of the temperature range is called the cold chain. The technical implementation is carried out by active and/or passive cooling containers of different sizes for the individual route sections. Active cooling containers work with a cooling unit that relies on a continuous power supply to maintain the temperature. This is usually provided by batteries, which are integrated into the cooling containers. Passive cooling containers usually work with latent heat storage devices. These are pre-cooled and undergo a phase change during transport, whereby the heat penetrating from the outside is absorbed.

Despite the availability of suitable cooling technologies, a large proportion of temperature-sensitive drugs, such as vaccines, still become unusable due to temperature deviations during transport. The reasons for this are often lack of planning, unforeseen events during transport or errors in the handling of the cooling containers. Since the individual phases of temperature-controlled transports are typically carried out by different companies, e.g. phase 1: Transport by plane to a country of destination; Phase 2: Distribution of drugs domestically to pharmacies and wholesalers, it is difficult to control all processes centrally.

To solve this problem, temperature and location sensors which record the internal temperature of the transport container and the ambient temperature as well as the position of the transport container during transport, are being used increasingly, whereby the data is merged and processed in computer-implemented systems. This makes it possible to prove at the destination that the drugs were not outside the prescribed temperature range at any time during transport, or in the event of a deviation, the place and time of the temperature excursion can be determined and appropriate measures taken for future deliveries.

There are also systems for planning temperature-controlled transports. By defining a delivery route with indication of ambient temperatures and time periods of the individual route sections, the thermal behavior of different cooling containers can be calculated and compared with each other. In some systems, it is also possible to take current weather data into account when creating the ambient temperature profile. Systems of this type, as described, for example, in U.S. Pat. No. 11,150,146 B1, make it possible to make decisions about the best cooling containers, transport routes or delivery times before a delivery in order to avoid temperature deviations or to save costs.

However, existing computer-implemented systems are not able to take into account the variance of the individual parameters, such as transport times, ambient temperatures and thermodynamic properties of the cooling containers. Only a mean value or a worst case assumption is considered. In addition, it is not possible to monitor a transport in real time and to detect at an early stage whether a temperature deviation occurs in the further progression of the transport or is to be expected with a high probability.

### SUMMARY OF THE INVENTION

The invention therefore aims to provide a method that enables planning and real-time monitoring of worldwide deliveries of temperature-sensitive drugs with early prediction of a temperature excursion.

To achieve this goal, according to a first aspect, the invention provides a computer-implemented method for planning and monitoring a cold chain during the transport of temperature-sensitive goods in a temperature-controlled transport container from a starting point to a destination, comprising the steps of:
a) providing route sections of at least one transport route, at least one means of transport being assigned to at least one of the route sections,
b) providing route section-specific estimated data, comprising estimated ambient temperature data and estimated transport duration data,
c) providing container-specific data, comprising thermodynamic key figures,
d) creating at least one combination of route sections for at least one transport route from the starting point to the destination,
e) calculating and displaying an expected progression of the internal temperature of the transport container for the at least one combination of route sections from the route section-specific estimated data and the container-specific data, wherein the expected progression of the internal temperature is within a predefined temperature range,
f) recording route section-specific actual data during transport, comprising actual ambient temperature data and actual transport duration data,
g) updating the calculation of the expected progression of the internal temperature of the transport container for a remaining part of the transport route, during transport, taking into account the route section-specific actual data.

The method according to the invention is particularly suitable for transport operations in which a passive cooling container is used in at least one of the route sections, preferably in all route sections, in particular a transport container with latent heat storage devices.

Due to the fact that step a) is based on route sections to which at least one means of transport can be assigned, section-specific and means of transport-specific parameters of the transport route can be taken into account during the planning and monitoring of a transport of goods. A route section is to be understood, for example, as a section of the transport route in which the transport container is transported by a means of transport. This could be air transport, truck transport or rail transport, for example. However, a route section can also be an intermediate station between two successive sections in which the transport container is not transported but is in transit or stored. This comprises, for example, the transport container being stored in cold stores, warehouses and loading bays. A route section can therefore also represent a time period of the transport.

In step b), route section-specific estimated data comprising estimated ambient temperature data and estimated transport duration data is associated with the route sections. The ambient temperature data may comprise temperatures indoors, such as in cold stores, warehouses, loading docks, in the cargo hold of an aircraft, or in the cargo hold of a truck, or outdoors, such as on airfields, outdoor storage bays, or open cargo bays. In the case of indoor areas, the estimated ambient temperature data are, in particular, empirical values based on measurements. In the case of outdoor areas, the estimated ambient temperature data is determined based in particular on weather forecasts. Together with the estimated transport duration data, data is therefore available for each route section, which allows an estimate to be made of how long the transport container will be exposed to which ambient temperature.

In step c), container-specific data is provided, specifically the thermodynamic key figures of one or more transport containers. The thermodynamic key figures may comprise, for example, the thermal conductivity of the insulation materials, the insulation thickness, the enthalpy and amount of coolant used, and the like. The thermodynamic key figures are selected in such a way that a thermodynamic calculation of the temporal progression in the internal temperature of the transport container can be carried out on the basis of the time profile of the ambient temperature.

In step d), depending on a transport request indicating a starting point and a destination of the transport, at least one combination of route sections is created, which results in a complete transport route from the starting point to the destination. In this case, several combinations of route sections can also be proposed, one combination of which can be selected for the actual transport. The different combinations can represent transport routes that are different from one another, i.e. transport routes that lead from the starting point to the destination via intermediate stations that are different from one another, or represent the same transport route that differ from one another in the choice of transport means.

In step e), an expected progression of the internal temperature of the transport container for the at least one combination of route sections is calculated and displayed from the route section-specific estimated data and the container-specific data. For each of the route sections contained in the combination, the estimated ambient temperature data assigned to it and the estimated transport duration data are used, and a thermodynamic calculation of the expected temperature progression is performed using the container-specific data, and the expected temperature progressions of the successive route sections are combined to form an overall profile of the expected internal temperature. In this case, various route section combinations can be calculated and at least one route section combination can be output, in which the expected progression of the internal temperature lies within a predefined temperature range. If multiple route section combinations are contemplated where the expected progression of the internal temperature is within a predefined temperature range, a user may make a selection. In any case, at the end of step e), there is a route section combination which is used for transporting the transport container from the starting point to the destination.

In step e), a temporal component can also be included as an additional variable in the calculation of various route section combinations, in particular variations in the start time and the arrival time of the transport. When planning a transport, the desired arrival time can be determined, for example, together with an acceptable deviation, e.g. +/−3 days.

In step f), during transport, the route section-specific actual data, namely, the actual ambient temperature and the actual transport duration, if possible for each route section, are collected, made available to the system and recorded. This is done, for example, by means of suitable temperature sensors attached to or in the transport container, or by querying current temperature data from a weather service in combination with a system for tracking the position of the transport container. The actual ambient temperature can be detected continuously or at certain time intervals. In particular, the actual ambient temperature is detected at least once in each route section. Preferably, the actual ambient temperature is recorded at intervals of no more than 1-2 minutes.

Position tracking can be performed by means of a receiver of a global navigation satellite system mounted in or on the transport container, or by detecting the transport container as it passes through stationary control points.

Since the route section-specific actual data may differ from the route section-specific estimated data, the invention now provides according to step g) that during transport, the calculation of the expected progression of the internal temperature of the transport container for a remaining part of the transport route is updated taking into account the route section-specific actual data. This update can preferably be made several times during the transport process. As part of the update, the progression of the internal temperature calculated for the previous part of the transport route in step e) is preferably corrected on the basis of the route section-specific actual data, and the final temperature of the corrected temperature profile is used as the starting point for recalculating the expected progression of the internal temperature for the remaining part of the transport route. The recalculation is carried out analogously to step e) using the temperature data estimated for the remaining part of the transport route and the container-specific data.

As a result, the prediction of the internal temperature progression becomes more and more accurate over time. In particular, it is advantageous if the route section-specific actual data and the position data of the transport container are present, as it were, in real time, i.e. with a maximum time delay of 1-5 minutes after the measurement, so that real-time monitoring of the transport container and prompt updating of the expected internal temperature progression are ensured. The frequency of the update operations depends on how often new route section-specific actual data and position data are available. For example, data transmission is not possible during aircraft transport, but data can be transmitted at intervals of, for example, 5-10 minutes during land carriage.

The updated progression of the internal temperature can be used to estimate whether the temperature may be exceeded or undershot during the rest of the transport. In this context, a preferred embodiment of the invention provides that the expected progression of the internal temperature for the remaining part of the transport route is compared with the predefined temperature range, and an expected excursion from the temperature range is identified and indicated. The expected excursion from the temperature range may be displayed on a screen, for example, in the form of a warning. If, for example, the transport process is delayed due to a flight cancellation, thereby increasing the probability of a temperature deviation above a defined limit, a warning is issued and possible solutions are proposed.

It is preferably possible to proceed in such a way that, at an expected excursion from the temperature range, changes in the transport are proposed, e.g. a change in the transport route, the route sections, the means of transport or the transport time. It may also be suggested to select a different transport container. For the generation of a proposal, the procedure is preferably analogous to step e), wherein the calculation of different combinations of route sections and means of transport takes place only for the remaining part of the transport route. In particular, for each of the route sections of the remaining part of the transport route included in the respective combination, the respectively associated estimated ambient temperature data and the estimated transport duration data are used, and a thermodynamic calculation of the expected temperature progression is performed using the container-specific data, and the expected temperature progressions of the successive route sections are combined to form an overall progression of the expected internal temperature. The progressions resulting for the individual route section combinations are checked to see whether they lie within a predefined temperature range and the suitable route section combinations are used as a suggestion for a changed route guidance.

In addition to recording the ambient temperature, the actual internal temperature of the transport container can also be measured during transport and made available to the system. The actual, measured internal temperature may be used to verify the thermodynamic calculation of the expected internal temperature from the actual ambient temperature. For this purpose, according to a preferred embodiment of the invention, the calculation of the expected progression of the internal temperature of the transport container for a previous part of the transport route is updated during the transport, taking into account the route section-specific actual data. Furthermore, the updated, calculated progression of the internal temperature for the previous part of the transport route is compared with the actual progression of the internal temperature and any deviation is identified, the deviation preferably being used to correct the container-specific data and step g) being carried out with additional consideration of the corrected container-specific data. This means that it is concluded from a deviation of the internal temperature calculated from the actual ambient temperature and the thermodynamic key figures of the transport container from the measured internal temperature that the transport container behaves thermally differently than expected, for example, which can increase the probability of leaving the defined temperature range. On this basis, a warning message can be issued and, if necessary, an automatic or manual correction of the thermodynamic key figures of the transport container can be carried out.

The decision on an optimal combination of route sections, means of transport, transport times and transport container type can depend not only on compliance with the predefined temperature range of the internal temperature, but also on additional criteria. In particular, it is desirable if the associated costs and the CO2-balance can also be included in the selection of the transport parameters.

In this context, a preferred development of the invention provides that the route section-specific estimated data further comprise an estimated CO₂-balance of the means of transport and/or that the container-specific data comprise a CO₂-balance of the transport container, wherein in step e) an expected CO₂-balance for the combination of route sections is additionally calculated from the estimated CO₂-balance of the respective means of transport and/or from the CO₂-balance of the transport container. In order to determine the CO₂-balance, the entire life span of the transport container from production to disposal can be taken into account.

Alternatively or additionally, it may be provided that the route section-specific estimated data further comprise estimated costs of the means of transport and/or that the container-specific data comprise costs of the transport container, wherein in step e) expected costs for the combination of route sections are additionally calculated from the estimated costs of the respective means of transport and/or from the costs of the transport container. The costs may comprise air transport costs per volume and weight as well as rental or procurement costs of the transport container.

The planning of the transport process can be further improved if different types of transport containers can be taken into account when optimizing the transport. A preferred embodiment of the invention provides that the container-specific data comprise thermodynamic key figures and, optionally, the CO₂-balance and, optionally, the costs of a plurality of different container types, and that, in step e), expected progressions of the internal temperature and, optionally, expected CO₂-balances and, optionally, expected costs are calculated for each of the plurality of container types, and one of the container types is selected for transport. Possible container types are, for example, disposable cooling containers made of cardboard and Styrofoam, thermal blankets, reusable cooling containers of different sizes and different equipment with cooling media.

As already mentioned, estimates for route section-specific data, comprising estimated ambient temperature data and estimated transport duration data, as well as container-specific data, comprising thermodynamic key figures, are used as input parameters for calculating the expected temperature progression of the internal temperature. The predictive quality of the internal temperature progression therefore depends on the accuracy of the estimation of the input parameters.

In order to be able to take into account, when calculating the expected temperature progression, that the estimation of the input parameters is subject to a certain uncertainty, according to a preferred embodiment, the estimated ambient temperature data and the estimated transport duration data are each in the form of an estimated temperature range and an estimated time duration range, respectively. In addition, the other input parameters, namely the container-specific data, the CO₂-balance of the transport containers and/or the means of transport, and the costs of the transport containers and/or the means of transport, may also be present in the form of range specifications.

The expected progression of the internal temperature is preferably obtained by calculating, in step e), for the at least one combination of route sections, preferably for each of the plurality of combinations of route sections, by varying the estimated temperature data within the temperature range and by varying the estimated transport duration within the duration range, a dispersion of the expected progression of the internal temperature and, if applicable, of the expected CO₂-balance and, if applicable, of the expected costs for the at least one combination, preferably for each of the plurality of combinations of route sections.

A further improvement can be achieved if, with regard to the input parameters, not only their mean values or maximum values, but also their variance can be taken into account. In this context, it is preferably provided that the estimated ambient temperature data and the estimated transport duration data are each in the form of a probability distribution of the temperature or the transport duration. The probability distribution may be provided, for example, in the form of a density function. In addition, the other input parameters, namely the container-specific data, the CO₂-balance of the transport containers and/or the means of transport, and the costs of the transport containers and/or the means of transport, may also be present in the form of a probability distribution.

The input parameters are preferably processed in such a way that the output parameters are also output in the form of a probability distribution. For this purpose, the procedure is preferably such that in step e), for the at least one combination of route sections, preferably for each of the plurality of combinations of route sections, a probability distribution of the expected progression of the internal temperature and, if applicable, the expected CO₂-balance and, if applicable, the expected costs for the at least one combination, preferably for each of the plurality of combinations of route sections, is calculated from the probability distributions of the temperature and the transport duration.

The probability distribution is characterized, for example, by a mean value and a dispersion, i.e. a distribution of individual values around the mean value. In particular, the probability distribution may be in the form of a normal distribution.

In order to be able to detect whether, for example, a obtained distribution of the expected internal temperature progression makes it probable that the predefined temperature range will be left or not, a certain scattering interval of the normal distribution can be used and it can be checked whether the limits of the scattering interval move out of the predefined temperature range. Specifically, the scattering interval may correspond to a predefined multiple of the standard deviation of the probability distribution.

According to a further aspect of the present invention, a system for data processing is provided, comprising means for carrying out the method according to the invention. The data processing system can be formed by a commercially available data processing device, wherein a central computer unit is preferably provided, to which all data necessary for carrying out the method according to the invention are fed, in particular:
data representing the starting point and the destination
data representing the route sections
data representing the means of transport
data representing the transport containers (types)
route section-specific estimated data, including estimated ambient temperature data and estimated transport duration data
container-specific data, including thermodynamic parameters
if applicable, estimated CO2-balances of the means of transport and the transport containers
if applicable, estimated costs of the means of transport and the transport containers
position data of the transport container
route section-specific actual data measured during transport, including actual ambient temperature data and actual transport duration data,
if applicable, the actual course of the container's internal temperature.

The data processing system can further interact with an input unit for inputting data and/or control commands and with an output unit, such as a screen.

According to another aspect of the present invention, a computer program product is provided comprising instructions that, when the program is executed by a computer, cause the computer to execute the method of the invention.

### BRIEF DESCRIPTION OF THE DRAWINGS

The invention is explained in more detail below with reference to exemplary embodiments illustrated in the drawing. In this

FIG. 1 shows a flowchart of a transportation planning system,

FIG. 2 shows an example of the calculation of the temperature progression in the transport container,

FIG. 3 shows a calculation of the probability of a temperature deviation from the temperature in the transport container and

FIG. 4 shows a flowchart for a real-time monitoring system.

### DETAILED DESCRIPTION

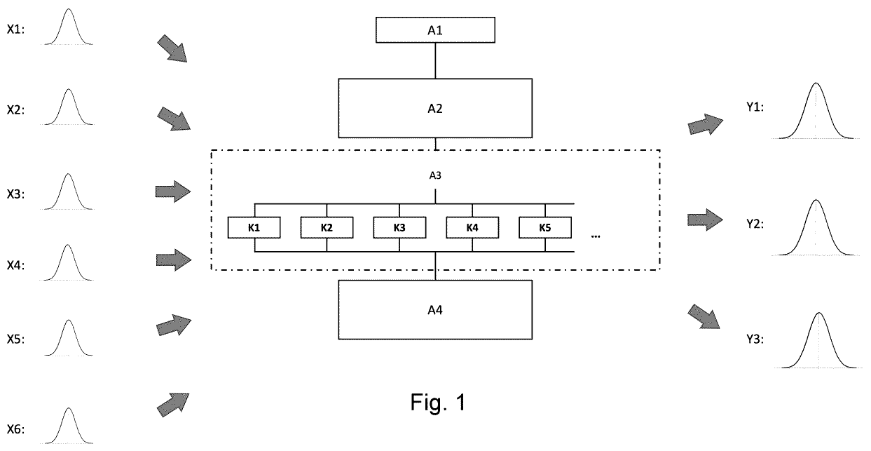

FIG. 1 shows a plurality of input parameters X1, X2, . . . X6, which are supplied to the method according to the invention, which calculates output parameters Y1, Y2 and Y3 therefrom.
X1 represents statistical ambient temperature data in indoor areas for route sections along the transport route based on measurements taken in the past, e.g. on closed, cooled truck and aircraft loading areas, in cold stores, in warehouses and on loading ramps.
X2 represents statistical ambient temperature data in outdoor areas for route sections along the transport route, which are based either on measurements carried out in the past or on forecast data of a weather forecast, e.g. on airfields, outdoor storage areas and loading areas of non-temperature-controlled trucks.
X3 represents statistical data regarding the transport duration in the individual route sections.
X4 represents thermodynamic key figures of different transport containers, taking into account the manufacturing variance, e.g. thermal conductivities of the insulation materials, insulation thicknesses, enthalpy and amount of coolant used.
X5 presents statistical data on the CO₂-balances of different means of transport and transport containers, taking into account the entire life span from production to disposal of the cooling containers.
X6 presents statistical data on the costs of the means of transport and transport containers, e.g. air transport costs per volume and weight, rental or procurement costs of the transport containers.

In the example shown here, the input parameters X1, X2, . . . X6 are present in the form of a probability distribution.

With these input parameters, a transport of temperature-sensitive goods is now planned and monitored with the aim that a predefined temperature range in the interior of the transport container should not be left. In the first step A1, the starting point and destination as well as the desired arrival time are defined. In step A2, numerous combinations of route sections, means of transport and types of transport containers are determined using the input parameters X1, X2, . . . X6.

In step A3, probabilistic methods are used to calculate the output parameters Y1, Y2 and Y3 in the form of a probability distribution for each combination (K1, K2, K3, K4, K5 . . . ) by varying the input parameters. Here, Y1 represents the probability distribution of the internal temperature of the transport container, Y2 represents the probability distribution of the overall CO₂-balance of the transport process, and Y3 represents the probability distribution of the total costs of the transport process.

In step A4, the individual combinations are compared with regard to the respective output parameters Y1, Y2 and Y3, and the best combination is determined and selected for carrying out the transport process. The selection of the best combination can be made with regard to a simultaneous optimization of all three output parameters, whereby a higher weighting can be assigned to one or two output parameters within the scope of the optimization than to the other output parameter.

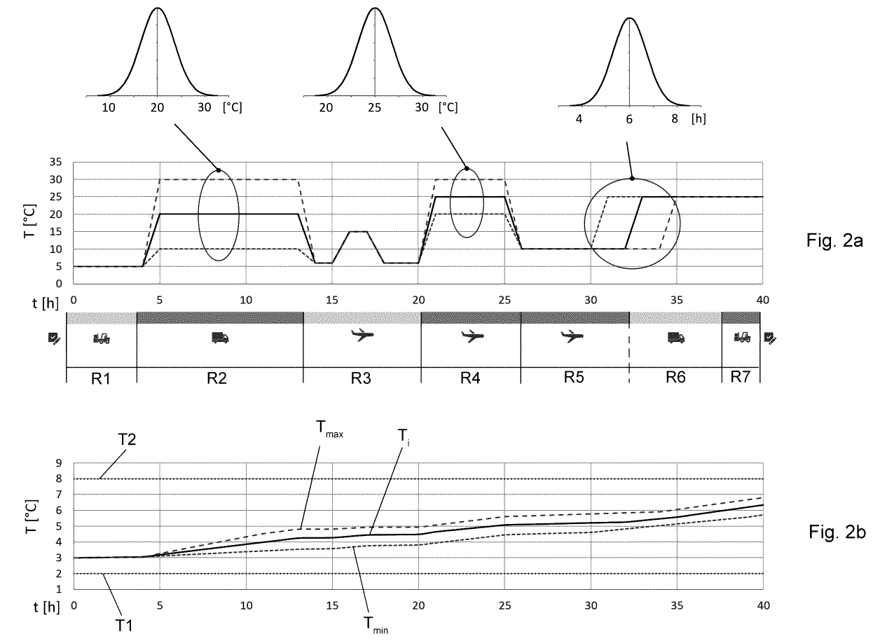

FIGS. 2a and 2b show the calculation of the output parameter Y1, i.e. the progression of the internal temperature of the transport container, using a concrete example of a transport route consisting of several route sections.

FIG. 2a shows estimated ambient temperature data (T [° C.]) and estimated transport duration data (t [h/hours]) for each route section. In the first route section R1, the transport container is stored in a cold store and is then prepared with a forklift for the subsequent truck transport. The route section R1 is assigned an estimated ambient temperature of 5° C., this value comprising no variance because it is a temperature-controlled cold store. In the second route section R2, the transport container is transported in a non-temperature-controlled truck, the estimated ambient temperature being 20° C. with a variance of ±10° C. In route section R3, the transport container is located in a temperature-controlled interim storage facility at the airport, the estimated ambient temperature being indicated as 15° C. In route section R4, the transport container is temporarily stored at the airfield before it is loaded into the cargo hold of the aircraft. Here, the estimated ambient temperature is based on forecast data from a weather forecast service and is 25±5° C. In route section R5, the transport container is transported in the cargo hold of an aircraft, where the estimated ambient temperature is 10° C. The transport duration is subject to uncertainty and comprises a variance of +2 hours. In route section R6, the transport container is transported further in a temperature-controlled truck and finally brought to its destination in route section R7 with a forklift, the respective estimated ambient temperature being 25° C.

In those cases where the estimated ambient temperature and the estimated transport duration comprise a variance, this may be input in the form of a probability distribution, as graphically illustrated in FIG. 2a.

FIG. 2b illustrates the result of calculating the expected progression of the internal temperature Tᵢ of the transport container, wherein the calculation is based on the estimated ambient temperature and estimated transport duration of each route section, as well as the thermodynamic key figures of the transport container, as illustrated in FIG. 2a. The variance or probability distribution of the input parameters is taken into account in the calculation, so that the expected progression of the internal temperature also comprises a corresponding variance, as shown in FIG. 2 with the dashed lines Tₘₐₓ and Tₘᵢₙ. The predefined temperature range that cannot be left during transportation is defined in FIG. 2b by the lower temperature limit T1 and the upper temperature limit T2. It is assumed that the predefined temperature range T1-T2 is left if Tₘᵢₙ falls below the lower temperature limit T1 or Tₘₐₓ exceeds the upper temperature limit T2.

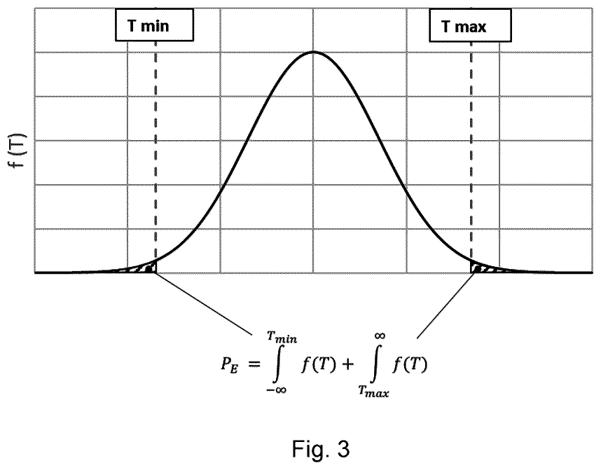

The expected internal temperature may also be output in the form of a probability distribution, as illustrated in FIG. 3. Tₘₐₓ and Tₘᵢₙ are defined here as a predefined multiple of the standard deviation of the normal distribution function, wherein the probability of leaving the predefined temperature range T1-T2 can be calculated using the formula given in FIG. 3.

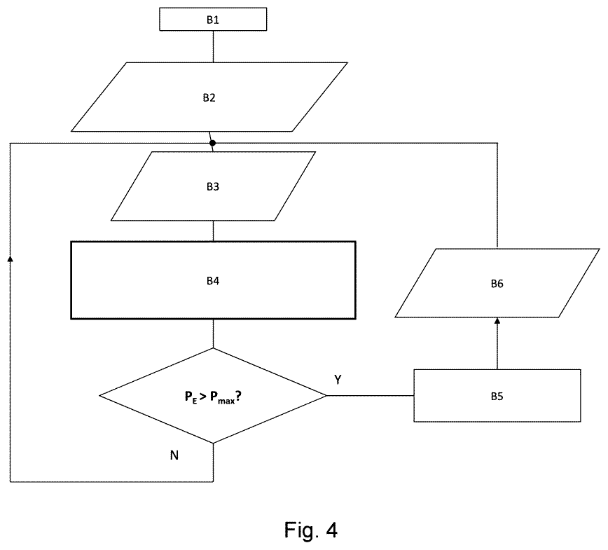

The invention makes it possible to carry out real-time monitoring of the transport process, as illustrated in FIG. 4. In step B1, the starting point and destination as well as the desired arrival time are defined, which corresponds to step Al of FIG. 1. In step B2, the optimal combination of route sections, means of transport, and transport container type is selected and read in, which corresponds to step A4 of FIG. 1. Now, in step B3, the input parameters X1, X2 and X3 are read in in real time during transport, so that the expected temperature progression for the remaining part of the transport route is updated, and in step B4 the probability of leaving the predefined temperature range can be calculated therefrom. If the probability P_{E} of leaving the predefined temperature range is greater than a predefined upper limit Pₘₐₓ (“N”), the output of a warning in the specification of proposed solutions follows in step B5. In step B6, the user selects one of the possible solutions. Thereafter, the system returns to step B3 and real-time monitoring of the transport process continues with the changed configuration. If the probability P_{E} of leaving the predefined temperature range is less than a predefined upper limit Pₘₐₓ (“N”), real-time monitoring of the transport process is also continued.

1-15. (canceled)

16. A computer-implemented method for planning and monitoring a cold chain during transport of temperature-sensitive goods in a temperature-controlled transport container from a starting point to a destination, the computer-implemented method comprising
a) providing route sections of at least one transport route, wherein at least one means of transport is assigned to each of the route sections;
b) providing route section-specific estimated data comprising estimated ambient temperature data and estimated transport duration data;
c) providing container-specific data comprising thermodynamic key figures;
d) creating at least one combination of route sections for at least one transport route from the starting point to the destination;
e) calculating and displaying an expected progression of the internal temperature of the transport container for the at least one combination of route sections from the route section-specific estimated data and the container-specific data, wherein the expected progression of the internal temperature is within a predefined temperature range;
f) recording route section-specific actual data during transport comprising actual ambient temperature data and actual transport duration data; and
g) updating the calculation of the expected progression of the internal temperature of the transport container, during transport, for a remaining part of the transport route, taking the route section-specific actual data into account.

17. The method according to claim 16, further comprising comparing the expected progression of the internal temperature for the remaining part of the transport route with the predefined temperature range, and identifying and indicating an expected excursion from the temperature range.

18. The method according to claim 17, wherein, at an expected excursion from the temperature range, changes in the transport are proposed.

19. The method according to claim 18, wherein the changes in the transport comprise one of a change in the transport route, the route sections, the means of transport, and a time of transport

20. The method according to claim 16, further comprising updating the calculation of the expected progression of the internal temperature of the transport container, during transport, for a previous part of the transport route, taking the route section-specific actual data into account.

21. The method according to claim 16, further comprising measuring the actual progression of the internal temperature of the transport container, during transport, and comparing the updated, calculated progression of the internal temperature for the previous part of the transport route with the actual progression and identifying a deviation, wherein step g) is performed with additional consideration of the corrected container-specific data.

22. The method according to claim 21, wherein the deviation is used to correct the container-specific data.

23. The method according to claim 16, wherein:
the route section-specific estimated data further comprises at least one of:
an estimated CO₂-balance of the means of transport, and
in that the container-specific data comprises a CO₂-balance of the transport container; and
in step e) an expected CO₂-balance for the combination of route sections is additionally calculated from at least one of:
the estimated CO₂-balance of the respective means of transport, and
the CO₂-balance of the transport container.

24. The method according to claim 16, wherein:
at least one of:
the route section-specific estimated data further comprises estimated costs of the means of transport, and
that the container-specific data comprises costs of the transport container; and
in step e) expected costs for the combination of route sections are additionally calculated from at least one of:
the estimated costs of the respective means of transport, and
the costs of the transport container.

25. The method according to claim 16, wherein the container-specific data comprises thermodynamic key figures and in that, in step e), expected progressions of the internal temperature and one of the container types is selected for transport.

26. The method according to claim 25, wherein the container-specific data further comprises a CO₂-balance.

27. The method according to claim 25, wherein in step e) expected costs are calculated for each of the plurality of container types.

28. The method according to claim 16, wherein in step d) several combinations of route sections are created for the at least one transport route from the starting point to the destination, and in step e) the expected progression of the internal temperature and one of the combinations is selected for transport.

29. The method according to claim 28, wherein in step e) the expected CO₂-balance is calculated for each of the plurality of combinations of route sections.

30. The method according to claim 16, wherein:
the estimated ambient temperature data and the estimated transport duration data are each in a form of an estimated temperature range and an estimated duration range, respectively;
if applicable, at least one of the following are also in a form of estimated ranges:
the container-specific data,
the CO₂-balance of the transport containers, and
the means of transport; and
if applicable, at least one of the following are also in a form of estimated ranges:
the costs of the transport containers, and
the means of transport.

31. The method according to claim 30, wherein in step e), for the at least one combination of route sections, by varying the estimated temperature data within the temperature range and by varying the estimated transport duration within a time duration range, a dispersion of the expected progression of the internal temperature and, if applicable, the expected CO₂-balance and, if applicable, the expected costs for the at least one combination, is calculated.

32. The method according to claim 16, wherein:
the estimated ambient temperature data and the estimated transport duration data are each in the form of a probability distribution of the estimated temperature range and the estimated duration range;
if applicable, at least one of the following are also in the form of a probability distribution:
the container-specific data,
the CO₂-balance of the transport containers, and
the means of transport; and
if applicable, at least one of the following are also in the form of a probability distribution:
the costs of the transport containers, and
the means of transport.

33. The method according to claim 32, wherein in step e), for the at least one combination of route sections, a probability distribution of the expected progression of the internal temperature and, if applicable, the expected CO₂-balance and, if applicable, the expected costs for the at least one combination, is calculated from the probability distributions of the temperature and the transport duration.

34. A data processing system comprising means for carrying out the method according to claim 16.

35. A computer program product comprising instructions that, when the program is executed by a computer, cause the computer to perform the method according to claim 16.
